(19) United States
(12) Patent Application Publication
(10) Pub. No.: US 2024/0205171 A1
(43) Pub. Date: Jun. 20, 2024

(54) Dynamically Reconfigurable Network

(71) Applicant: The United States of America, as represented by the Secretary of the Navy, San Diego, CA (US)

(72) Inventor: Thang Hoang Ho, San Diego, CA (US)

(21) Appl. No.: 18/081,841

(22) Filed: Dec. 15, 2022

(51) Int. Cl. H04L 49/90; H04L 41/084; H04L 41/0893

(52) U.S. Cl. CPC H04L 49/90; H04L 41/084; H04L 41/0893

(57) ABSTRACT

A dynamically reconfigurable network presents external ports. The dynamically reconfigurable network includes a configuration register, a physical layer, and protocol stacks. The configuration register dynamically specifies a particular configuration selected from available configurations of the dynamically reconfigurable network. The physical layer interconnects ports with multiplexing controlled by the configuration register for realizing the available configurations capable of connecting from each of the ports to any one or more of the ports. The particular configuration from the configuration register specifies current connections to each of the ports from a respective one of the ports. The ports include the external ports of the dynamically reconfigurable network and internal ports. The protocol stacks each include at least a routing layer and a switching layer, with the switching layer connected to at least one of the internal ports.

### FEDERALLY-SPONSORED RESEARCH AND DEVELOPMENT

The United States Government has ownership rights in this invention. Licensing and technical inquiries may be directed to the Office of Research and Technical Applications, Naval Information Warfare Center Pacific, Code 72120, San Diego, CA, 92152; voice (619) 553-5118; NIWC_Pacific_T2@us.navy.mil. Reference Navy Case Number 112961.

### BACKGROUND OF THE INVENTION

Traditional network systems rely on fixed function hardware that are high in size, power, and weight (SWaP) and are non-adaptive. To change network function or modify existing device interconnections, the hardware must be swapped out, the backplane must be redesigned, manufactured, requalified, rewired, and redeployed. These changes are time consuming, costly, and prone to errors.

### SUMMARY

A dynamically reconfigurable network presents external ports. The dynamically reconfigurable network includes a configuration register, a physical layer, and protocol stacks. The configuration register dynamically specifies a particular configuration selected from available configurations of the dynamically reconfigurable network. The physical layer interconnects ports with multiplexing controlled by the configuration register for realizing the available configurations capable of connecting from each of the ports to any one or more of the ports. The particular configuration from the configuration register specifies current connections to each of the ports from a respective one of the ports. The ports include the external ports of the dynamically reconfigurable network and internal ports. The protocol stacks each include at least a routing layer and a switching layer, with the switching layer connected to at least one of the internal ports.

### BRIEF DESCRIPTION OF THE DRAWINGS

Throughout the several views, like elements are referenced using like references. The elements in the figures are not drawn to scale and some dimensions are exaggerated for clarity.

FIG. 1 is a block diagram of a dynamically reconfigurable network in accordance with an embodiment of the invention.

### DETAILED DESCRIPTION OF EMBODIMENTS

The disclosed systems below may be described generally, as well as in terms of specific examples and/or specific embodiments. For instances where references are made to detailed examples and/or embodiments, it should be appreciated that any of the underlying principles described are not to be limited to a single embodiment, but may be expanded for use with any of the other systems and methods described herein as will be understood by one of ordinary skill in the art unless otherwise stated specifically.

Embodiments of the invention describe a dynamically reconfigurable network that creates a flexible network platform and enables rapid iterative approaches to design, implementation, and testing of dynamic software-defined network architectures. Fixed networks are not suitable for today's mobile network architectures. In contrast, the dynamically reconfigurable network allows the same hardware to support multiple functions. The functions of the dynamically reconfigurable network are defined by the end user rather than the vendor's profit driven mandate. Moreover, the adaptability of the dynamically reconfigurable network lowers total cost of ownership and enables routine replacement of hardware components without necessarily changing the system design.

Embodiments of the invention provide both hardware and software that are software reconfigurable (i.e., software-defined). The entire system can be implemented on a single integrated circuit (IC). Software functions include the packet routing of the routing layer corresponding to layer 3 of the Open Systems Interconnection (OSI) model and optionally frame switching of the switching layer corresponding to layer 2 of the OSI model. Hardware functions include interfacing with the communication media, interconnections remapping, hardware acceleration, processing that supports the software functions, and optionally frame switching. An important advantage of the dynamically reconfigurable network is that the same device can be used implement the physical layer 1, the switching layer 2, the routing layer 3, and even an application layer, as well as any combination thereof. In addition, the interconnections of the physical layer can be remapped without rewiring the backplane or swapping hardware.

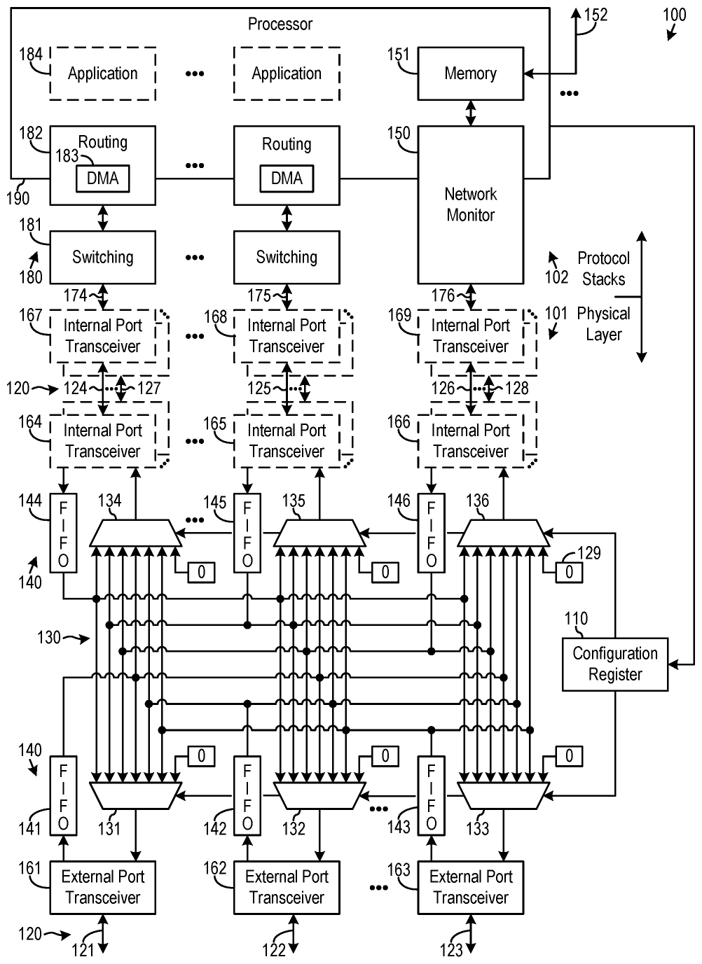

FIG. 1 is a block diagram of a dynamically reconfigurable network 100 in accordance with an embodiment of the invention. The dynamically reconfigurable network 100 includes a configuration register 110, a physical layer 101, and protocol stacks 102. The dynamically reconfigurable network 100 presents external ports 121 and 122 through 123.

The configuration register 110 dynamically specifies a particular configuration selected from available configurations of the dynamically reconfigurable network 100. The physical layer 101 interconnects ports 120 with multiplexing 130 controlled by the configuration register 110. The ports 120 include the external ports 121 and 122 through 123 of the dynamically reconfigurable network 100 and internal ports 124 through 125 and 126. Each multiplexer 131 and 132 through 133 and 134 through 135 and 136 of the multiplexing 130 is controlled by the configuration register 110 to select one of the inputs of the multiplexer. The multiplexing 130 realizes the available configurations capable of connecting from each of the ports 120 to any one or more of the ports 120. The particular configuration from the configuration register 110 specifies current connections to each of the ports 120 from a respective one of the ports 120. For example, multiplexer 136 is capable of connecting any of the ports 120 (including port 126) to port 126.

In one embodiment, multiplexing 130 can connect a null input to any unused ports 120. For example, if port 126 is unused then the configuration register 110 configures multiplexer 136 to connect the null input 129 to the unused port 126.

In one embodiment, the configuration register 110 is mechanical switches for selecting the particular configuration from the available configurations. For example, the number of inputs to each of the multiplexers 131 and 132 through 133 and 134 through 135 and 136 of the multiplexing 130 is a power of two specified as 2^{N}, and the configuration register 110 includes N switches for each multiplexer with these N switches encoding which input is selected by the multiplexer.

The physical layer 101 includes first-in first-out (FIFO) queues 140 including FIFO queues 141 and 142 through 143 and 144 through 145 and 146. The FIFO queues 140 include a respective FIFO queue for each of the ports 120. Correspondingly, the multiplexing 130 includes a respective multiplexer for each of the ports 120. The ports 120 are bidirectional ports in one embodiment. The particular configuration from the configuration register 110 specifies the current connections between each one of the bidirectional ports 120 and a corresponding one of the bidirectional ports 120. For example, if external port 122 and internal port 124 are currently connected with a bidirectional connection, then the configuration register 110 specifies that multiplexer 132 selects input from FIFO queue 144, and specifies multiplexer 134 selects input from FIFO queue 142. Often, but not always as discussed below, pairs of the ports 120 are currently connected with a bidirectional connection as specified in the configuration register 110.

In general when the ports 120 are bidirectional ports, the respective FIFO queue for a first bidirectional port receives data from the first bidirectional port. The respective multiplexer for a corresponding second bidirectional port is controlled by the particular configuration from the configuration register 110 to deliver the data from the respective FIFO queue for the first bidirectional port to the corresponding second bidirectional port. The respective FIFO queue for the first bidirectional port receives data from the first bidirectional port at a first data rate of the first bidirectional port. The respective multiplexer for the corresponding second bidirectional port sends the data from the respective FIFO queue for the first bidirectional port to the corresponding second bidirectional port at a second data rate of the corresponding second bidirectional port. The first and corresponding second bidirectional ports usually differ and the first and second data rates sometimes differ, with the FIFO queues providing buffering for accommodating different data rates.

Typically during a normal operating mode, the respective multiplexer for the corresponding second bidirectional port is controlled by the particular configuration from the configuration register 110 to deliver the data from the respective FIFO queue for the first bidirectional port to the corresponding second bidirectional port, and symmetrically the respective multiplexer for the first bidirectional port is controlled by the particular configuration from the configuration register 110 to deliver the data from the respective FIFO queue for the corresponding second bidirectional port to the first bidirectional port.

However, the connections are not symmetric in other operating modes when the ports 120 are bidirectional ports. During a loopback test mode, the respective multiplexer for a loopback port of the ports 120 is controlled by the particular configuration from the configuration register 110 to deliver the data from the respective FIFO queue for the loopback port to the same loopback port. During the loopback test mode, any subset of one or more up to all of the ports 120 become loopback ports. The loopback test mode is useful for verifying connections.

Another scenario when the connections are not symmetric is during monitoring with the network monitor 150. For example, suppose external port 122 and internal port 124 are currently connected with a bidirectional connection with multiplexers 132 and 134 appropriately configured by the configuration register 110. To monitor the outgoing traffic from internal port 124 to external port 122, multiplexer 136 for the network monitor 150 is controlled by the particular configuration from the configuration register 110 to deliver data from the FIFO queue 144 to the internal port 126 for the network monitor 150. Note this results in two multiplexers 132 and 136 in parallel forwarding the data from the FIFO queue 144 at generally the same data rate.

More generally during the monitoring mode, the network monitor 150 receives the data from the specific port 126 dedicated to the network monitor 150 and stores the data in a memory 151. Typically, the network monitor 150 does not transmit anything to the specific port 126 and FIFO queue 146 during the monitoring mode. However, after monitoring completes and during a readout mode, the network monitor 150 transmits the data traces stored in the memory 151 to the specific port 126 for forwarding to one of the ports 120 connected to a display for displaying the data traces. Alternatively, another external port 152 provides access to data traces stored in the memory 151.

In summary, a specific port 126 of the internal ports of the ports 120 is dedicated to the network monitor 150. At least one selected port of the ports 120 is selected for monitoring by the network monitor 150. The respective multiplexer for a third port of the ports 120 is controlled by the particular configuration from the configuration register 110 to deliver the data from the respective FIFO queue for the selected port to the third port. The respective multiplexer 136 for the specific port 126 is controlled by the particular configuration from the configuration register 110 to, in parallel, deliver the data from the respective FIFO queue for the selected port to the specific port 126 dedicated to the network monitor 150.

The physical layer 101 further includes, for each of the external ports external ports 121 and 122 through 123, a respective transceiver 161 and 162 through 163 for transmitting to a communication media and for receiving from the communication media. For example, the external ports 121 and 122 through 123 are bidirectional Ethernet ports, and their respective physical respective transceivers 161 and 162 through 163 support a communication media for Megabit Ethernet, 10 Megabit Ethernet, 100 Megabit Ethernet, Gigabit Ethernet, 10 Gigabit Ethernet, or 100 Gigabit Ethernet.

The physical layer 101 optionally includes a respective transceiver 164 through 165 and 166 for each of the internal ports 124 through 125 and 126. However, preferably the transceivers 164 through 165 and 166 are omitted along with the corresponding transceivers 167 through 168 and 169. Instead, the internal ports 124 through 125 and 126 are virtual internal ports. For example, the internal ports 174 through 175 and 176 are bidirectional Ethernet ports complying with the Media Independent Interface (MII), Reduced Media Independent Interface (RMII), Gigabit Media Independent Interface (GMII), Reduced Gigabit Media Independent Interface (RGMII), Serial Gigabit Media Independent Interface (SGMII), or Quad Serial Gigabit Media Independent Interface (QSGMII). The internal ports 174 through 175 and 176 are appropriately connected to the FIFO queues 144 through 145 and 146 and the multiplexers 134 through 135 and 136. For example, internal port 174 complying with the Gigabit Media Independent Interface (GMII) is directly connected to FIFO queue 144 and the multiplexer 134, or indirectly connected to FIFO queue 144 and the multiplexer 134 via a relatively small amount of conversion logic, such as a GMII-RGMII converter between Gigabit Media Independent Interface (GMII) and Reduced Gigabit Media Independent Interface (RGMII).

Preferably the transceivers 164 through 165 and 166 and the transceivers 167 through 168 and 169 are omitted because this simplifies the dynamically reconfigurable network 100 while retaining the functions of these transceivers of interfacing with the internal ports 124 through 125 and 126, even though the internal ports 124 through 125 and 126 become virtual internal ports. For example, the retained functions include flow control on the communication media even though the communication media is also omitted. FIG. 1 includes transceivers 164 through 165 and 166 and the transceivers 167 through 168 and 169 to illustrate the symmetry between the external ports 121 and 122 through 123 and the internal ports 124 through 125 and 126 of the dynamically reconfigurable network 100. This symmetry is retained even though the dynamically reconfigurable network 100 does not include any transceivers for the internal ports 124 through 125 and 126 with the functions of these transceivers retained despite the omission of these transceivers.

The dynamically reconfigurable network 100 includes protocol stacks 102, which include a protocol stack for internal port 174 through another protocol stack for internal port 175. Each of the protocol stacks include at least a routing layer and a switching layer, wherein the switching layer is connected actually or virtually to at least one of the internal ports 124 through 125 and 126. For example, protocol stack 180 for internal port 174 includes the switching layer 181 and the routing layer 182. The protocol stack 180 also optionally includes an application layer 184. The network monitor 150 is considered to correspond to a protocol stack.

The switching layer 181 routes data frames that have a static or nearly static routing during the lifetime of a particular configuration stored in the configuration register 110. For example, the switching layer 181 forwards data frames between specified port pairs. Typically, the switching layer 181 is capable of forwarding frames between many virtual ports 124 through 127. However for clarity, FIG. 1 shows a representative FIFO queue 144 and a representative multiplexer 134 for only a single virtual port 124. The FIFO queue 144 and multiplexer 134 are duplicated for each additional port 127, and the multiplexer 134 and its duplicate each include more selectable inputs including a respective selectable input for each of the ports 120, including ports 124 through 127. In one embodiment, the switching layer 181 of the protocol stack 180 includes a media access controller (MAC) that is an AXI Ethernet.

Similarly, the network monitor 150 typically uses multiple ports 126 through 128. For example, again suppose external port 122 and internal port 124 are currently connected with a bidirectional connection with multiplexers 132 and 134 appropriately configured by the configuration register 110. To monitor both the outgoing traffic from internal port 124 to external port 122 and the incoming traffic from external port 122 to internal port 124, multiplexer 136 is configured by the configuration register 110 to connect the FIFO queue 144 to the internal port 126, and another duplicated multiplexer (not shown) is configured by the configuration register 110 to connect the FIFO queue 142 to the internal port 128.

When the protocol stack 180 implements a router that routes data packets between or among the internal ports 124 through 127, then the protocol stack 180 includes only the routing layer 182 and the switching layer 181 connected the internal ports 124 through 127. When the protocol stack 180 implements a higher level function, such as a web server, then the protocol stack 180 includes not only the routing layer 182 and the switching layer 181, but further includes an application layer 184.

In one embodiment as shown in FIG. 1, the switching layer 181 is implemented in hardware, but the routing layer 182 is implemented in software executing on the processor 190, with the direct memory access (DMA) engine 183 bridging between the hardware and software domains. A respective DMA engine is coupled with the memory 151 for each of the protocol stacks 102. The DMA engine 183 transfers ingress data and egress data between the memory 151 and at least one of the internal ports 124 through 127 to which is connected the switching layer 181 of the protocol stack 180. The processor 190 is programmed to implement the routing layer of each of the protocol stacks 102. For each of the protocol stacks 102, the respective DMA engine interrupts the processor 190 after the respective DMA engine stores the ingress data in the memory 151, and the processor 190 awakens the respective DMA engine after the processor 190 stores the egress data in the memory 151.

The processor 190 is further programmed to implement an application layer of at least one of the protocol stacks 102 in one embodiment. For example, the processor 190 is programmed to implement the application layer 184 of the protocol stack 180. In one embodiment, the processor 190 is multiple processors each coupled with the memory 151. For example, processor 190 implements the application layer 184 and routing layer 182 of the protocol stack 180, and another processor similarly implements the remaining protocol stacks 102. In one embodiment, the processor 190 implements the network monitor 150 and also dynamically stores the particular configuration in the configuration register 110.

In one embodiment, an entirety of the dynamically reconfigurable network 100 is implemented in a system that is a field programmable gate array (FPGA), an FPGA coupled with a plurality of Ethernet transceivers, a system on a chip (SoC) coupled with an FPGA, or an application specific integrated circuit (ASIC).

From the above description of Dynamically Reconfigurable Network, it is manifest that various techniques may be used for implementing the concepts of the network 100 without departing from the scope of the claims. The described embodiments are to be considered in all respects as illustrative and not restrictive. The network 100 disclosed herein may be practiced in the absence of any element that is not specifically claimed and/or disclosed herein. It should also be understood that the network 100 is not limited to the particular embodiments described herein, but is capable of many embodiments without departing from the scope of the claims.

I claim:

1. A dynamically reconfigurable network presenting a plurality of external ports comprising:
a configuration register for dynamically specifying a particular configuration selected from a plurality of available configurations of the dynamically reconfigurable network;
a physical layer interconnecting a plurality of ports with multiplexing controlled by the configuration register for realizing the available configurations capable of connecting from each of the ports to any one or more of the ports, wherein the particular configuration from the configuration register specifies current connections to each of the ports from a respective one of the ports, and the ports include the external ports of the dynamically reconfigurable network and a plurality of internal ports; and
a plurality of protocol stacks each including at least a routing layer and a switching layer, wherein the switching layer is connected to at least one of the internal ports.

2. The dynamically reconfigurable network of claim 1, wherein the configuration register is a plurality of mechanical switches for selecting the particular configuration from the available configurations.

3. The dynamically reconfigurable network of claim 1, wherein the physical layer includes, for each of the external ports, a respective transceiver for transmitting to a communication media and for receiving from the communication media, but the dynamically reconfigurable network does not include any such transceivers for the internal ports.

4. The dynamically reconfigurable network of claim 1, wherein the physical layer includes:
a plurality of first-in first-out (FIFO) queues including a respective FIFO queue for each of the ports, which are bidirectional ports; and
the multiplexing including a respective multiplexer for each of the bidirectional ports, wherein the particular configuration from the configuration register specifies the current connections between each first one of the bidirectional ports and a corresponding second one of the bidirectional ports.

5. The dynamically reconfigurable network of claim 4, wherein the physical layer further includes, for each of the external ports, a respective transceiver for transmitting to a communication media and for receiving from the communication media, but the dynamically reconfigurable network does not include any such transceivers for the internal ports.

6. The dynamically reconfigurable network of claim 4, wherein:
the respective FIFO queue for the first one of the bidirectional ports receives data from the first one of the bidirectional ports; and
the respective multiplexer for the corresponding second one of the bidirectional ports is controlled by the particular configuration from the configuration register to deliver the data from the respective FIFO queue for the first one of the bidirectional ports to the corresponding second one of the bidirectional ports.

7. The dynamically reconfigurable network of claim 6, wherein:
the respective FIFO queue for the first one of the bidirectional ports receives data from the first one of the bidirectional ports at a first data rate of the first one of the bidirectional ports; and
the respective multiplexer for the corresponding second one of the bidirectional ports sends the data from the respective FIFO queue for the first one of the bidirectional ports to the corresponding second one of the bidirectional ports at a second data rate of the corresponding second one of the bidirectional ports, wherein the first and corresponding second ones of the bidirectional ports differ and the first and second data rates differ.

8. The dynamically reconfigurable network of claim 7, wherein, during a normal operating mode:
the respective multiplexer for the corresponding second one of the bidirectional ports is controlled by the particular configuration from the configuration register to deliver the data from the respective FIFO queue for the first one of the bidirectional ports to the corresponding second one of the bidirectional ports; and symmetrically
the respective multiplexer for the first one of the bidirectional ports is controlled by the particular configuration from the configuration register to deliver the data from the respective FIFO queue for the corresponding second one of the bidirectional ports to the first one of the bidirectional ports.

9. The dynamically reconfigurable network of claim 6, wherein, during a normal operating mode:
the respective multiplexer for the corresponding second one of the bidirectional ports is controlled by the particular configuration from the configuration register to deliver the data from the respective FIFO queue for the first one of the bidirectional ports to the corresponding second one of the bidirectional ports; and symmetrically
the respective multiplexer for the first one of the bidirectional ports is controlled by the particular configuration from the configuration register to deliver the data from the respective FIFO queue for the corresponding second of the bidirectional ports to the first one of the bidirectional ports.

10. The dynamically reconfigurable network of claim 6, wherein, during a loopback test mode, the respective multiplexer for the corresponding second one of the bidirectional ports is controlled by the particular configuration from the configuration register to deliver the data from the respective FIFO queue for the first one of the bidirectional ports to the corresponding second one of the bidirectional ports, and the first and corresponding second ones of the bidirectional ports are a same one of the bidirectional ports.

11. The dynamically reconfigurable network of claim 6, further comprising a network monitor, wherein:
a specific first port of the internal ports of the bidirectional ports is dedicated to the network monitor;
a selected second port of the bidirectional ports is selected for monitoring by the network monitor;
the respective multiplexer for another third port of the bidirectional ports is controlled by the particular configuration from the configuration register to deliver the data from the respective FIFO queue for the selected second port to the another third port; and
the respective multiplexer for the specific first port is controlled by the particular configuration from the configuration register to, in parallel, deliver the data from the respective FIFO queue for the selected second port to the specific port dedicated to the network monitor.

12. The dynamically reconfigurable network of claim 11, wherein:
during a monitoring mode, the network monitor receives the data from the specific port dedicated to the network monitor and stores the data in a memory, and the network monitor does not transmit anything to the specific port; and
during a readout mode, the network monitor transmits the data stored in the memory to the specific port for forwarding to one of the bidirectional ports.

13. The dynamically reconfigurable network of claim 1, wherein at least one of the protocol stacks routes data between or among a plurality of the internal ports and includes only the routing layer and the switching layer, which is connected to the plurality of the internal ports.

14. The dynamically reconfigurable network of claim 1, wherein at least one of the protocol stacks includes not only the routing layer and the switching layer, but further includes an application layer.

15. The dynamically reconfigurable network of claim 1, further comprising:
for each one of the protocol stacks, a respective direct memory access (DMA) engine coupled with a memory, wherein the respective DMA engine transfers ingress data and egress data between the memory and the at least one of the internal ports to which is connected the switching layer of the one of the protocol stacks; and
at least one processor coupled to the memory, wherein the at least one processor is programmed to implement the routing layer of each of the protocol stacks, wherein, for each of the protocol stacks, the respective DMA engine interrupts the at least one processor after storing the ingress data in the memory, and the at least one processor awakens the respective DMA engine after storing the egress data in the memory.

16. The dynamically reconfigurable network of claim 15, wherein the at least one processor is further programmed to implement an application layer of at least one of the protocol stacks.

17. The dynamically reconfigurable network of claim 15, wherein the at least one processor dynamically stores the particular configuration in the configuration register.

18. The dynamically reconfigurable network of claim 15, wherein the at least one processor is a plurality of processors each coupled with the memory.

19. The dynamically reconfigurable network of claim 1, wherein:
the physical layer includes, for each of the external ports that are bidirectional Ethernet ports, a respective physical transceiver supporting a communication media selected from the group consisting of Megabit Ethernet, 10 Megabit Ethernet, 100 Megabit Ethernet, Gigabit Ethernet, 10 Gigabit Ethernet, and 100 Gigabit Ethernet;
the internal ports are bidirectional Ethernet ports each selected from the group consisting of Media Independent Interface (MII), Reduced Media Independent Interface (RMII), Gigabit Media Independent Interface (GMII), Reduced Gigabit Media Independent Interface (RGMII), Serial Gigabit Media Independent Interface (SGMII), and Quad Serial Gigabit Media Independent Interface (QSGMII); and
the switching layer of each of the protocol stacks includes a respective media access controller (MAC) that is an AXI Ethernet.

20. The dynamically reconfigurable network of claim 1, wherein an entirety of the dynamically reconfigurable network is implemented in a system selected from the group consisting of a field programmable gate array (FPGA), an FPGA coupled with a plurality of Ethernet transceivers, a system on a chip (SoC) coupled with an FPGA, and an application specific integrated circuit (ASIC).
